(19) United States
(12) Patent Application Publication
(10) Pub. No.: US 2016/0042323 A1
(43) Pub. Date: Feb. 11, 2016

(54) RECRUITING PROCESS UTILIZING READINESS DATA FROM REFERENCE PROVIDERS

(71) Applicant: Chequed.com, Inc., Saratoga Springs, NY (US)

(72) Inventor: Gregory C. Moran, Ballston Spa, NY (US)

(21) Appl. No.: 14/454,810

(22) Filed: Aug. 8, 2014

(51) Int. Cl. G06Q 10/10; G06Q 50/00; G06Q 10/06

(52) U.S. Cl. CPC G06Q 10/1053; G06Q 10/067; G06Q 50/01

(57) ABSTRACT

A system, method and program product are provided for facilitating the recruitment process. The disclosed system includes: a communication system that provides automated communications with a set of reference providers over a network; a readiness inquiry system for collecting readiness data from the set of reference providers via the network, wherein the readiness data comprises electronic responses to a questionnaire; an analysis system that analyzes the readiness data for each reference provider, determines whether each reference provider is an active job seeker and assigns a readiness score to each reference provider; and a system for generating a readiness report that includes a readiness score for at least one reference provider, wherein the readiness score measures an interest in being recruited for a potential job position.

### TECHNICAL FIELD

The subject matter of this invention relates generally to a recruiting system and method that utilizes readiness data collected from reference providers to identify and score reference providers as potential job candidates.

### BACKGROUND

Recruiting qualified candidates for employment remains an ongoing challenge for almost all organizations. One common approach is to advertise for open positions using any of the various job posting services available, e.g., newspapers, web-based services, etc. However, potential candidates who are not out seeking a career change will not typically be reviewing such job postings. Accordingly, it is difficult with advertising to reach candidates that might consider a new job opportunity, but are otherwise not actively searching.

A further approach for identifying and recruiting qualified candidates is to utilize a professional recruiter to seek out potential candidates. This often entails cold calling potential candidates to feel out potential interests. Unfortunately, the use of recruiters is expensive, with fees often running tens of thousands of dollars for a single position.

Accordingly, new methods and systems for identifying job candidates are needed for the recruiting process.

### SUMMARY

In general, aspects of the present invention provide a solution for collecting and analyzing readiness data from reference providers to determine if the reference providers should be recruited as potential job candidates.

A first aspect of the invention provides a system for identifying job candidate recruits, comprising: a communication system that provides automated communications with a set of reference providers over a network; a readiness inquiry system for collecting readiness data from the set of reference providers via the network, wherein the readiness data comprises electronic responses to a questionnaire; an analysis system that analyzes the readiness data for each reference provider, determines whether each reference provider is an active job seeker and assigns a readiness score to each reference provider using a predictive model, wherein the predictive model is determined based on historical response patterns and outcomes; and a system for generating a readiness report that includes a readiness score for at least one reference provider, wherein the readiness score measures an interest in being recruited.

A second aspect of the invention provides a computer program product stored on computer readable medium, which when executed by a computer system, identifies job candidate recruits, comprising: program code that provides automated communications with a set of reference providers over a network; program code that collects readiness data from the set of reference providers via the network, wherein the readiness data comprises electronic responses to a questionnaire; program code that analyzes the readiness data for each reference provider, determines whether each reference provider is an active job seeker and assigns a readiness score to each reference provider using a predictive model, wherein the predictive model is determined based on historical response patterns and outcomes; and program code that generates a readiness report that includes a readiness score for at least one reference provider, wherein the readiness score measures an interest in being recruited for a potential job position.

A third aspect of the invention provides a computerized method of identifying job candidate recruits, comprising: generating automated communications with a set of reference providers over a network; collecting readiness data from the set of reference providers via the network, wherein the readiness data comprises electronic responses to a questionnaire; analyzing the readiness data for each reference provider to assign a readiness score to each reference provider using a predictive model, wherein the predictive model is determined based on historical response patterns and outcomes; and generating a readiness report that includes a readiness score for at least one reference provider, wherein the readiness score measures an interest in being recruited for a potential job position.

A fourth aspect of the invention provides a human resources assistant system accessible to a plurality of client organizations over a network, comprising: a reference checking system for providing automated reference checking services for client organizations, wherein the reference checking system automatically communicates electronic survey questions to reference providers, collects responses, and provides reference reports; a readiness inquiry system for collecting readiness data from the reference providers via the network, wherein the readiness data comprises electronic responses to a readiness questionnaire; an analysis system that analyzes the readiness data for each reference provider and assigns a readiness score to each reference provider; and a system for generating a readiness report that includes a readiness score for at least one reference provider, wherein the readiness score measures an interest in being recruited for a potential job position.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a HR assistant system according to embodiments of the present invention.

FIG. 2 shows a computer system having a recruiting system according to embodiments of the invention.

FIG. 3 shows a readiness questionnaire according to embodiments of the invention.

FIG. 4 shows a branded communication according to embodiments of the invention.

FIG. 5 shows a readiness report according to embodiments of the invention.

FIG. 6 shows a notification according to embodiments of the invention.

FIG. 7 shows a search system according to embodiments of the invention.

FIG. 8 shows a flow diagram of a method for recruiting using reference providers.

FIG. 9 shows an analysis system according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

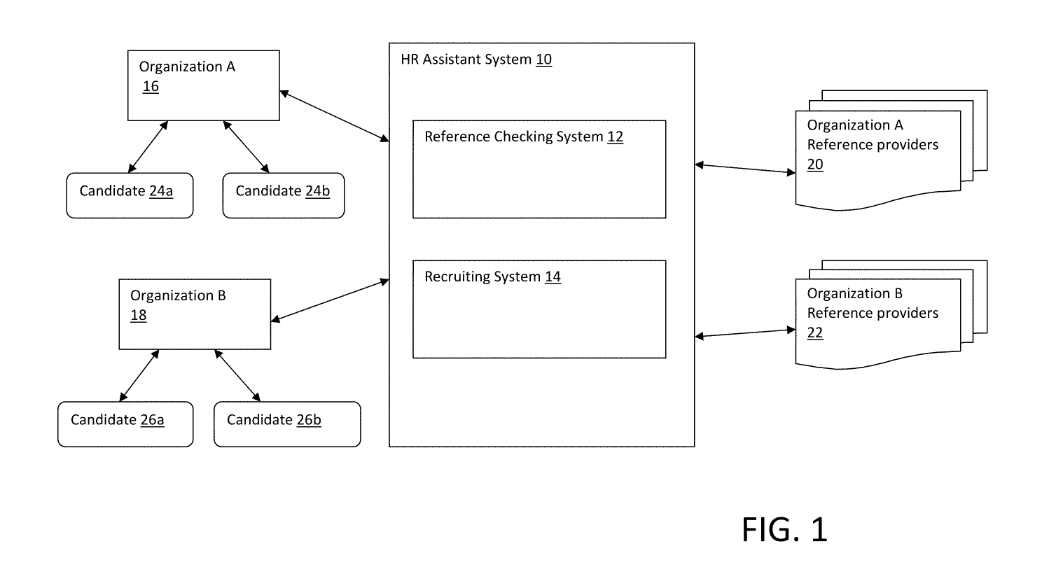

FIG. 1 depicts a human resources (HR) assistant system 10 that helps to manage aspects of the hiring process for client organizations 16, 18. HR assistant system 10 may for example be deployed as a web based service that provides services on a subscription basis to the client organizations 16, 18. Among its features, HR assistance system 10 includes a reference checking system 12 that provides an automated process for allowing client companies 16, 18 to manage reference checking for candidates 24a, 24b and 26a, 26b seeking positions with the respective client organizations 16, 18.

In one illustrative embodiment, reference checking system 12 utilizes an electronic communication to communicate with and collect information from reference providers 20, 22 for the candidates 24a, 24b and 26a, 26b. For example, candidates 24a, 24b seeking a position with Organization A may each provide the HR assistant system 10 a list of potential reference providers, along with email addresses. Reference checking system 12 would then automatically contact reference providers 20, e.g., via email, forward questionnaires, collect/track responses, and tabulate the results into a report. The report is then available for use by organization A in the hiring process. In a typical scenario, responses from reference providers 20, 22 would be confidential and include first hand information about the candidate's qualifications.

HR assistant system 10 further includes a recruiting system 14 that treats each of the reference providers 20, 22 as potential candidates for other potential job positions, either within the company or elsewhere. In particular, recruiting system 14 conducts an online information exchange with each reference provider 20, 22 to determine their interest in being considered for prospective positions. This may include email or other forms of online communication. For example, after the reference provider completes and submits a reference questionnaire for a candidate, recruiting system 14 may send a follow-up email asking if the reference provider would be interested in future opportunities. If the reference provides indicates “yes” then automated follow-up communications as described herein would follow.

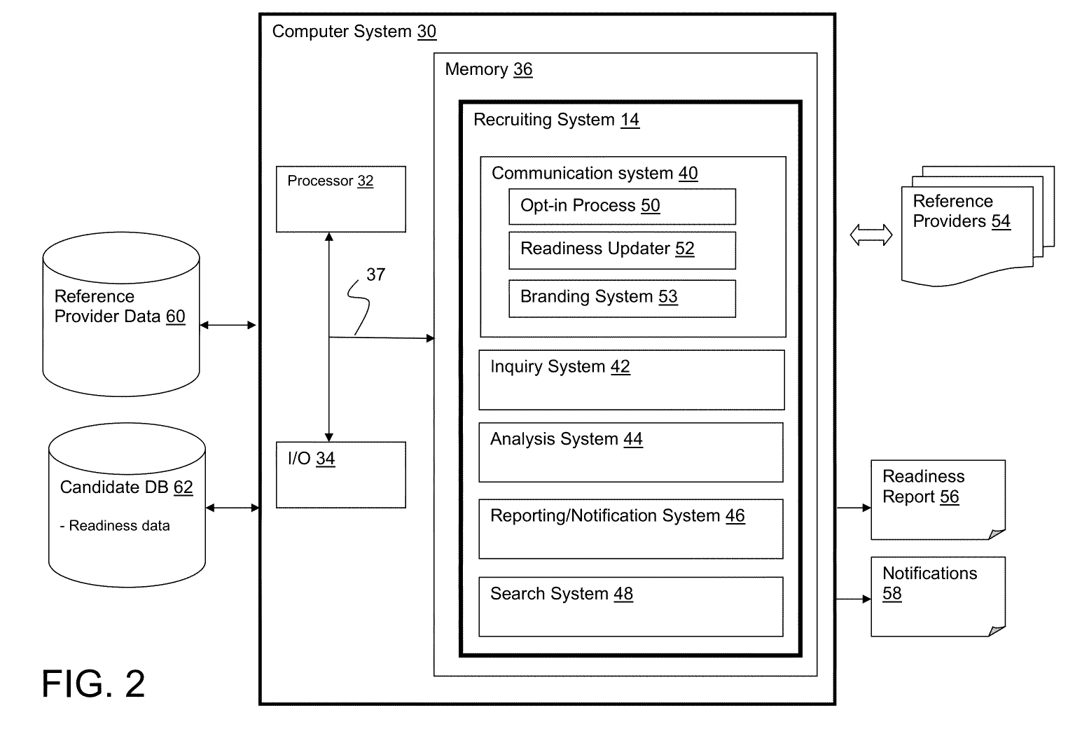

FIG. 2 depicts a computer system 30 for implementing recruiting system 14 for use by one or more client organizations. In this case, recruiting system 14 identifies and recruits potential candidates from the reference provider data 60. Reference provider data 60 includes data collected from reference checking system 12 (FIG. 1), and for example includes a database of reference provider names, email addresses and client organizations for which a reference was given, etc. Potential candidates from the reference providers are for example stored in a candidate database 62. Each candidate entry in the candidate database 62 includes collected readiness data 63 that can be used to measure a readiness or likelihood of interest in changing jobs.

In this illustrative embodiment, recruiting system 14 includes: a communication system 40 for communicating with reference providers 54, e.g., via email, SMS, etc.; a readiness inquiry system 42 for gathering readiness data 63 from reference providers 54, e.g., based on electronic questionnaires; an analysis system 44 for analyzing the readiness data 63; a reporting/notification system 46 for generating readiness reports 56 and notifications 58 for client organizations; and a search system 48 for allowing client organizations to search the candidate database 62.

Communication system 40 includes: an opt-in process 50 that allows a reference provider 54 the ability to “opt-in” and be considered a potential candidate for the client organization that requested the reference or for other organizations looking to hire; a periodic updater 52 that periodically (e.g., monthly) pings each reference provider 54 for current readiness data; and a branding system 53 that allows a client organization to insert branding information, e.g., logos, trademarks, etc., into electronic communications directed to reference providers 54.

The opt-in process 50 may for example comprise a clickable box included in an email to the reference provider 54 as part of the reference checking process. Alternatively, a separate email or other communication may be sent to the reference provider 54. In either case, the opt-in process 50 determines if reference provider 54 is interested in being recruited either now or sometime in the future for potential positions. If the reference provider 54 opts-in, the reference provider's information is placed into the candidate database 62.

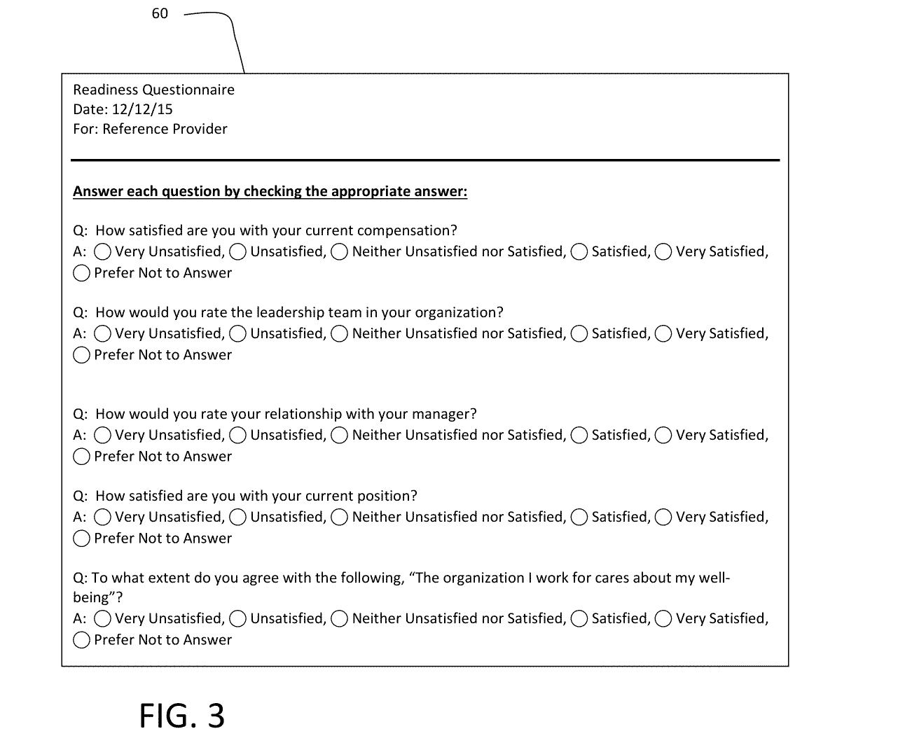

Assuming the reference provider 54 opts-in, communication system 40 causes readiness inquiry system 42 to send the reference provider 54 a brief electronic questionnaire (or link to a questionnaire). FIG. 3 depicts an example questionnaire 60 that includes a set of questions utilized to gather readiness data. The questionnaire 60 may, e.g., be encapsulated in an email, be contained in a web page served from the recruiting system 14, etc. A follow-up questionnaire, either with the same or different questions, may be presented to the reference provider periodically by periodic updater 52 to gage the candidate's readiness over time.

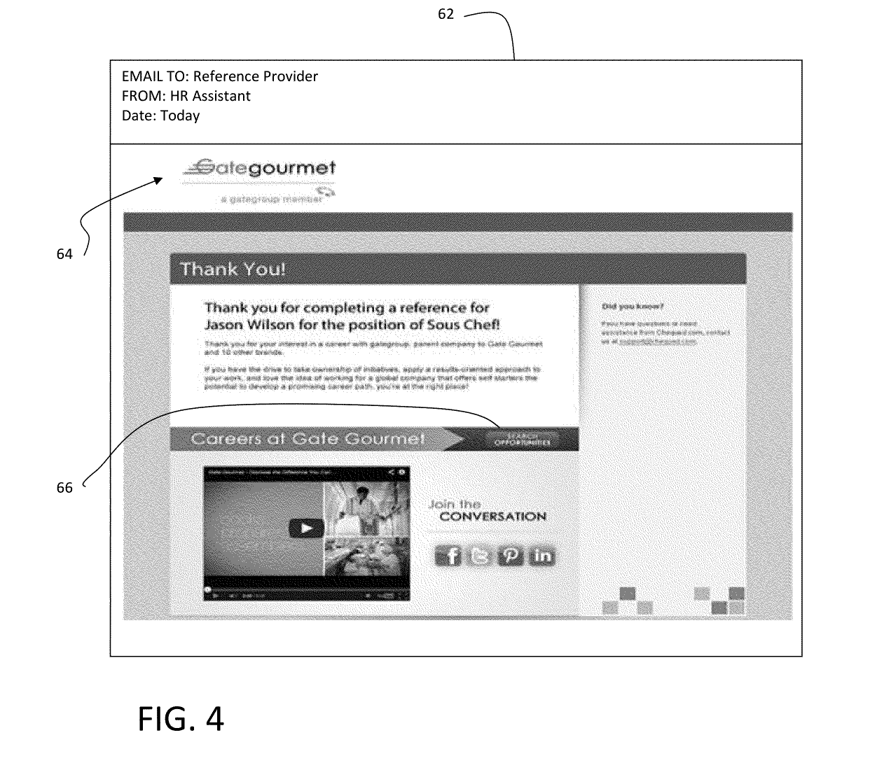

As noted, branding system 53 allows a client organization to insert branding information, e.g., logos, trademarks, etc., into any communications directed to reference providers 54. FIG. 4 depicts an illustrative email 62 directed to a reference provider that includes branding 64. The depicted email 62 comprises a thank you message from a client organization for completing a reference, and an opt-in button 66 to receive career opportunities at the client organization.

Analysis system 44 includes one or more algorithms for processing collected readiness data (e.g., questionnaire responses) for a potential candidate. Analysis system 44 characterizes each candidate as either a passive or active job seeker, and further generates and assigns a readiness score to each candidate. In general, a set of questions are presented and responses are collected from the reference provider. The questions are directed at specific criteria or categories that help to predict the responder's readiness to leave their current job for a new opportunity.

In the example shown in FIG. 3, the candidate provides responses to a series of inquiries along a Likert scale. In this illustrative embodiment, the questionnaire includes a question directed at current compensation; a question directed at current organizational leadership; a question directed at a current relationship with a manager; a question directed at current job satisfaction; and a question directed at caring by the organization. Although not shown, a further question may be presented directed at a time frame, e.g., for which the responder would consider a new job search. It is however understood that the questions and categories of questions may vary, and change over time as the analysis system 44 evolves.

The response from each question is translated into a numerical value, weighted with an importance factor, and combined into the readiness score. The weights in the analysis are developed from a statistical analysis of a large universe of potential candidates to determine the correlation of response patterns and their propensity to be recruited. The statistical analysis to determine the weighting is redone on a periodic basis to adjust the weights as the size of the reference provider universe grows and or changes.

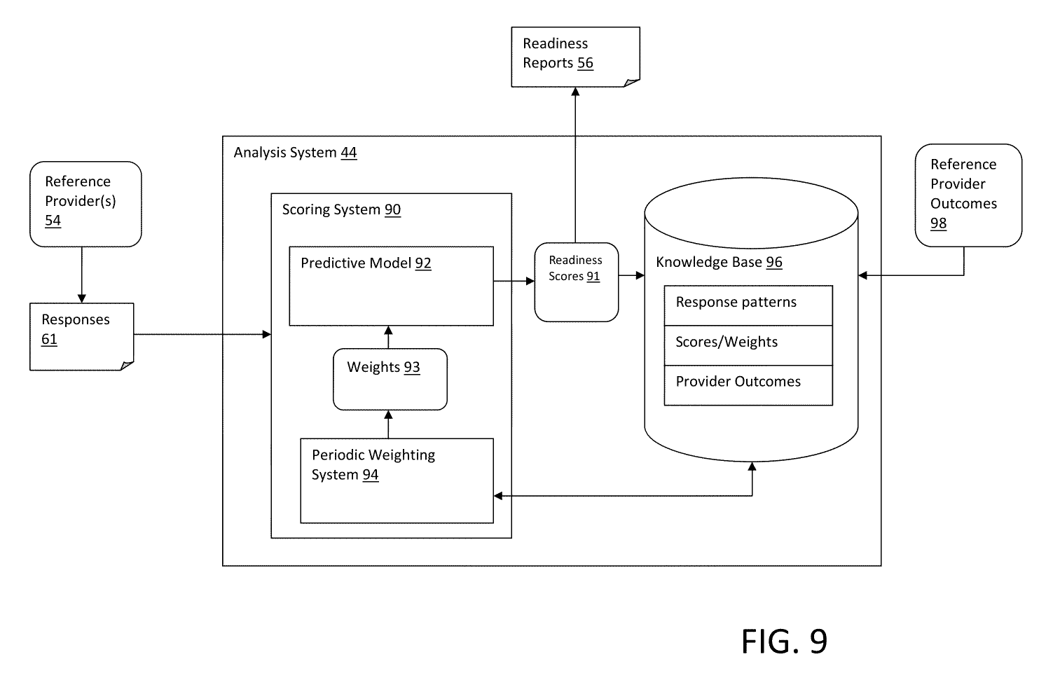

FIG. 9 depicts a detailed embodiment of an illustrative analysis system 44, which generally includes a scoring system 90 for scoring responses 61 received from reference providers 54 and a knowledge base 96 for storing response patterns, associated scores and weights, and reference provider outcomes 98.

Scoring system 90 utilizes a predictive model 92 that correlates a set of responses 61 (i.e., answers to a questionnaire) to a readiness score 91. In particular, predictive model 92 converts each response to a numerical value and then assigns a weight 93 to each of the responses. The resulting readiness score 91 is then outputted, e.g., to a readiness report 56, and is also stored in knowledge base 96. Weights 93 are periodically altered by periodic weighting system 94 based on updated information in knowledge base 96.

In addition to collecting readiness scores 91, knowledge base 96 also collects reference provider outcomes 98, which includes actual outcome data of participating reference providers that have already gone through (or are going through) the process. In particular, reference provider outcomes 98 may include, e.g., information about when a reference provider (i.e., candidate) actually began seeking a new position, when the candidate actually accepted a new position, how long the candidate stayed at the new position, whether the candidate was satisfied with the new position, etc. Thus, knowledge base 96 stores information about the response patterns provided by the reference provider to a questionnaire, the weights and scores associated with each response pattern, and actual reference provider outcomes 98 that occurred after the questionnaire was completed. Actual reference provider outcomes 98 may be collected by the HR assistant system 10 (FIG. 1) or any other system. For example, HR assistant system 10 may track such information as the reference provider goes through the recruitment process as follows:
Jul. 1, 2014: reference provider ID xxx for company yyy indicates that they are open to exploring opportunities and they complete a questionnaire; the result indicates they are a passive job seeker with a readiness score of 45.
Oct. 10, 2014: reference provider ID xxx re-submits the questionnaire; the result indicates that the candidate is now an active job seeker with a readiness score of 83.
Nov. 15, 2014: reference provider ID xxx begins interviewing for a position with company xyz and accepts the position on Dec. 1, 2014.
Jan. 31, 2015: reference provider ID xxx submits a feedback survey.

Periodic weighting system 94 periodically evaluates the information in knowledge base 96 to readjust weights 93 as the sampling size of the knowledge base information grows. For example, responses related to current compensation may initially be weighted higher than organizational leadership. However, as more actual reference provider outcomes 98 are collected, it might become statistically evident that organizational leadership is a better indicator of readiness to change jobs. Furthermore, certain overall response patterns within the Likert scale may indicate a greater propensity to leave a current position relative to other response patterns, based on historical outcomes. Thus, analysis system 44 utilizes historical response patterns and outcomes to tune the predictive model 92.

Predictive model 92 may utilize any type of predictive analytics to predict behaviors, i.e., assign weights 93 and ultimately determine a readiness score. In the example shown in FIG. 9, predictive model utilizes: (a) historical variables from past occurrences (i.e., actual reference provider outcomes) and (b) response variables obtained from questionnaires. Any type of modeling technique may be utilized, e.g., regression models, linear regression models, time series models, optimal discriminate analysis, neural networks, clustering, etc.

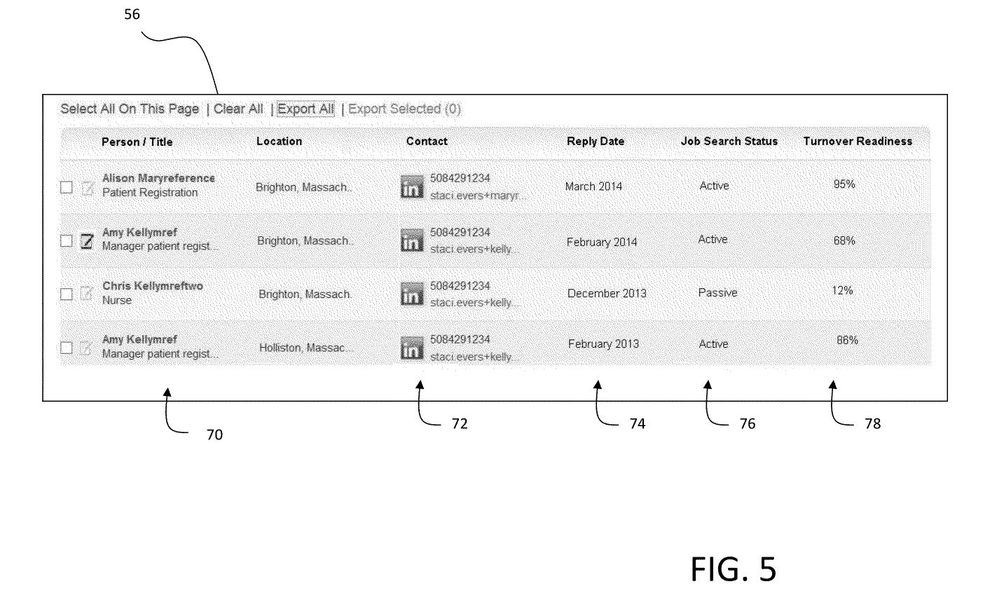

Reporting/notification system 46 generates readiness reports 56 and notifications 58 for the client organization. For example, FIG. 5 shows a readiness report 56 that provides a list of candidates 70, contact information 72, a reply date 74, an active/passive indicator 76 and a readiness score 78. It is understood that other information may be included in such a report. For example, individual candidate reports may be provided that show readiness scores over time (i.e., trends) for a given candidate. For instance, such a report may show that a candidate has a readiness score that has increased, remained the same, or decreased over a series of reporting periods.

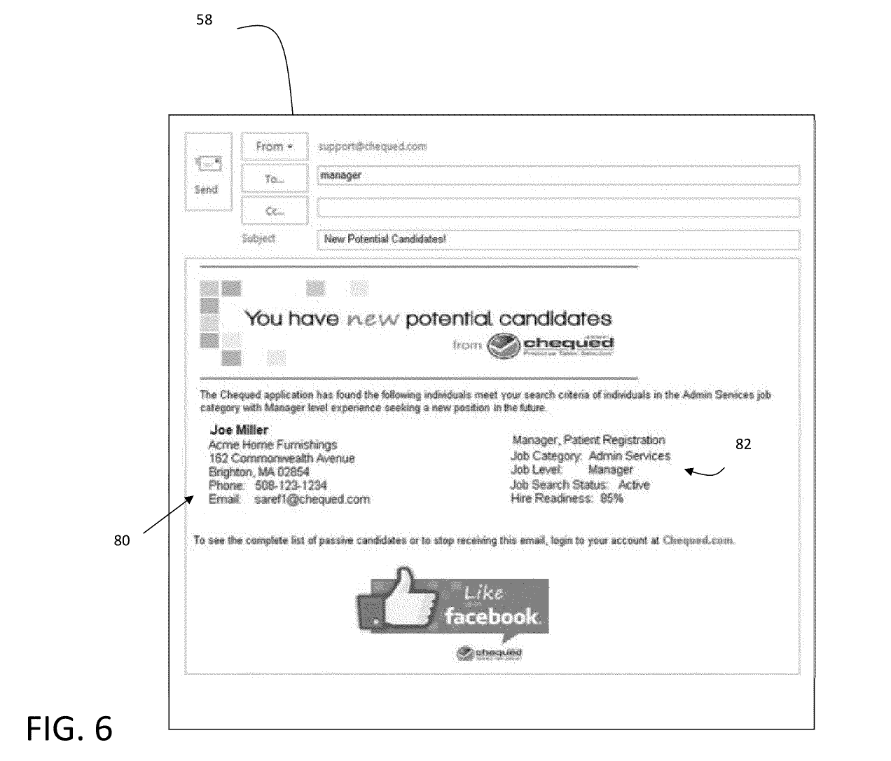

FIG. 6 shows an example of a notification 58. In this example, the notification 58 comprises an email directed to the manager of a client organization indicating that a new potential candidate 80 has been identified. In this case, notification 58 includes associated details 82, including a job category and level, an active/passive indicator, and a readiness score. Notifications 58 could be generated in any fashion, e.g., SMS, via social media, etc. Notifications 58 may include any relevant information and be generated according to any criteria.

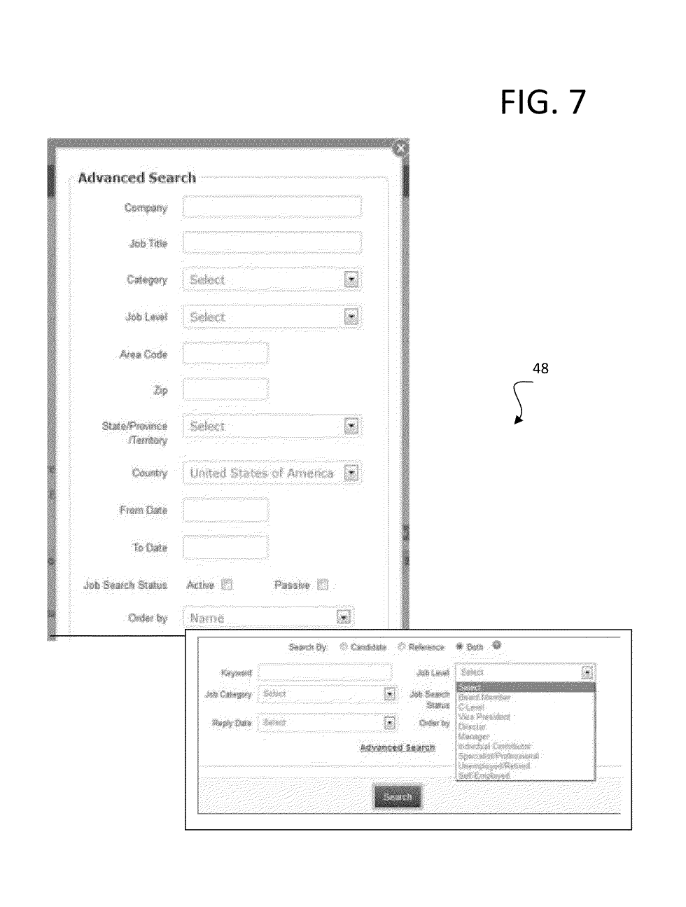

FIG. 7 depicts a search system 48 that allows a client organization to search candidate database 62 (FIG. 2) for possible candidates for a given position. Any type of known search interface for accessing data from a database could be utilized. In one illustrative embodiment, the user could further limit the search to only active or passive candidates, candidates that have a readiness score above a selected threshold, candidates in specific geographic areas, or any other criteria.

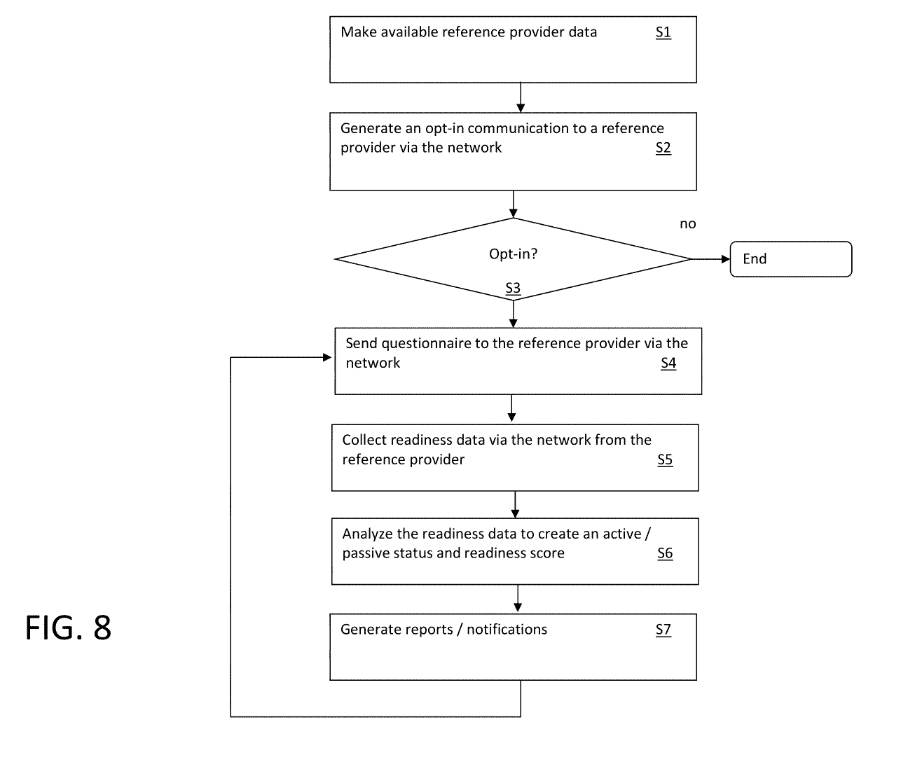

FIG. 8 depicts a flow diagram of a method of the invention. At S1, reference provider data is made available, e.g., from a data source, from a reference provider system, from an HR assistant system, etc., and at S2 an opt-in communication is generated and sent to a reference provider via a network. Assuming the reference provider opts-in at S3, a readiness questionnaire (or link to the questionnaire) is sent to the reference provider via the network at S4. At S5, readiness data is collected from the reference provider and at S6 the readiness data is analyzed to create an active/passive status and a readiness score. At S7, readiness reports and notifications are sent to the appropriate client organization(s). The process loops back to S4 after a period of time to update the readiness status.

The present invention may be implemented as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 2 depicts an illustrative computer system 30 that may comprise any type of computing device and, and for example includes at least one processor 32, memory 36, an input/output (I/O) 34 (e.g., one or more I/O interfaces and/or devices), and a communications pathway 37. In general, processor(s) 32 execute program code, such as recruiting system 14, which is at least partially fixed in memory 36. While executing program code, processor(s) 32 can process data, which can result in reading and/or writing transformed data from/to memory 36 and/or I/O 34 for further processing. Pathway 37 provides a communications link between each of the components in computer system 30. I/O 34 can comprise one or more human I/O devices, which enable a user to interact with computer system 30. To this extent, recruiting system 14 can manage a set of interfaces (e.g., graphical user interfaces, application program interfaces, etc.) that enable humans and/or other systems to interact with the recruiting system 14. Further, recruiting system 14 can manage (e.g., store, retrieve, create, manipulate, organize, present, etc.) data using any solution. In addition, although not shown, a complete HR assistant system 10 (FIG. 1) may likewise be implemented within computer system 30, or another similar system.

For the purposes of this disclosure, the term database may include any system capable of storing data including tables, data structure, XML files, etc.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for identifying job candidate recruits, comprising:
a communication system that provides automated communications with a set of reference providers over a network;
a readiness inquiry system for collecting readiness data from the set of reference providers via the network, wherein the readiness data comprises electronic responses to a questionnaire;
an analysis system that analyzes the readiness data for each reference provider, determines whether each reference provider is an active job seeker and assigns a readiness score to each reference provider using a predictive model, wherein the predictive model is determined based on historical response patterns and outcomes; and
a system for generating a readiness report that includes a readiness score for at least one reference provider, wherein the readiness score measures an interest in being recruited.

2. The system of claim 1, wherein the set of reference providers are selected from a database that stores information associated with individuals who previously provided an electronic reference via the network for third party candidates seeking job positions.

3. The system of claim 2, wherein the at least one reference provider provided a reference for a client organization and a potential job position for which the reference provider is being recruited is with the client organization.

4. The system of claim 2, wherein the at least one reference provider provided a reference for a client organization and the potential job position is with a different client organization.

5. The system of claim 1, wherein the questionnaire comprises a set of questions that collect responses along a Likert scale.

6. The system of claim 5, wherein the questionnaire includes:
at least one question directed at current compensation;
at least one question directed at current organizational leadership;
at least one question directed at a current relationship with a manager;
at least one question directed at current job satisfaction;
at least one question directed at caring by the organization; and
at least one question directed at a time frame for a new job search.

7. The system of claim 6, wherein a response from each question is translated into a numerical value, weighted with an importance factor, and combined into the readiness score.

8. The system of claim 1, wherein the communication system automatically generates periodic communications with the set of reference providers to collect updated readiness data.

9. The system of claim 8, wherein the periodic communications include branded content for a client organization.

10. A computer program product stored on computer readable medium, which when executed by a computer system, identifies job candidate recruits, comprising:
program code that provides automated communications with a set of reference providers over a network;
program code that collects readiness data from the set of reference providers via the network, wherein the readiness data comprises electronic responses to a questionnaire;
program code that analyzes the readiness data for each reference provider, determines whether each reference provider is an active job seeker and assigns a readiness score to each reference provider using a predictive model, wherein the predictive model is based on historical response patterns and outcomes; and
program code that generates a readiness report that includes a readiness score for at least one reference provider, wherein the readiness score measures an interest in being recruited for a potential job position.

11. The computer program product of claim 10, wherein the wherein the set of reference providers are selected from a database that stores information associated with individuals who previously provided an electronic reference via the network for third party candidates seeking job positions.

12. The computer program product of claim 10, wherein the questionnaire comprises a set of questions that collect responses along a Likert scale.

13. The computer program product of claim 12, wherein the questionnaire includes:
at least one question directed at current compensation;
at least one question directed at current organizational leadership;
at least one question directed at a current relationship with a manager;
at least one question directed at current job satisfaction;
at least one question directed at caring by the organization; and
at least one question directed at a time frame for a new job search.

14. The computer program product of claim 12, wherein a response from each question is translated into a numerical value, weighted with an importance factor, and combined into the readiness score.

15. A computerized method of identifying job candidate recruits, comprising:
generating automated communications with a set of reference providers over a network;
collecting readiness data from the set of reference providers via the network, wherein the readiness data comprises electronic responses to a questionnaire;
analyzing the readiness data for each reference provider to assign a readiness score to each reference provider using a predictive model, wherein the predictive model is based on historical response patterns and outcomes; and
generating a readiness report that includes a readiness score for at least one reference provider, wherein the readiness score measures an interest in being recruited for a potential job position.

16. The computerized method of claim 15, wherein the set of reference providers are selected from a database that stores information associated with individuals who previously provided an electronic reference via the network for third party candidates seeking job positions.

17. The computerized method of claim 15, wherein the questionnaire comprises a set of questions that collect responses along a Likert scale.

18. The computerized method of claim 17, wherein the questionnaire includes:
at least one question directed at current compensation;
at least one question directed at current organizational leadership;
at least one question directed at a current relationship with a manager;
at least one question directed at current job satisfaction;
at least one question directed at caring by the organization; and
at least one question directed at a time frame for a new job search.

19. The computer program product of claim 18, wherein a response from each question is translated into a numerical value, weighted with an importance factor, and combined into the readiness score.

20. A human resources assistant system accessible to a plurality of client organizations over a network, comprising:
a reference checking system for providing automated reference checking services for client organizations, wherein the reference checking system automatically communicates electronic survey questions to reference providers, collects responses, and provides reference reports;
a readiness inquiry system for collecting readiness data from the reference providers via the network, wherein the readiness data comprises electronic responses to a readiness questionnaire;
an analysis system that analyzes the readiness data for each reference provider and assigns a readiness score to each reference provider; and
a system for generating a readiness report that includes a readiness score for at least one reference provider, wherein the readiness score measures an interest in being recruited for a potential job position.
